(19) United States
(12) Patent Application Publication
(10) Pub. No.: US 2005/0111918 A1
(43) Pub. Date: May 26, 2005

(54) Landfill gas recovery system

(75) Inventor: Jamie L. Yeager, Seward, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: Bentley Development Co., Inc., Blairsville, PA (US)

(21) Appl. No.: 10/969,803

(22) Filed: Oct. 20, 2004

Related U.S. Application Data
(60) Provisional application No. 60/513,163, filed on Oct. 21, 2003.

(51) Int. Cl. B09C 1/00; B09B 1/00

(52) U.S. Cl. 405/129.85; 405/128.15; 405/129.95

(57) ABSTRACT

A gas management system for collecting landfill gas (LFG) is provided, comprising a gas header pipe buried within stable ground outside of and surrounding a landfill cell, condensation discharge wells connected to the gas header pipe at predetermined low points of the gas header pipe, and containment units sealed to the liner system of a landfill cell for sealed penetration of lateral line pipes to communicate gas wells in the landfill cell to the gas header pipe. A method for collecting LFG is provided, comprising providing the system adapted for use with a landfill cell to receive LFG emitted from the landfill, collecting the gas emitted from the landfill by drawing the gas under vacuum through the system to a processing station for separating methane from LFG, and discharging condensation pooling in the reservoirs of the condensation discharge wells of the system by an automatic, pneumatic pump system.

### BACKGROUND OF THE INVENTION

1. Field of the Invention

The invention relates to a gas management system and methods therefor for collecting landfill gas emission from decomposition of solid waste in landfills, which requires less maintenance than current landfill gas recovery systems and is capable of environmental regulatory compliance. Specifically, a landfill gas management system and methods therefor are provided, the system having a gas header pipe with condensation discharge wells positioned within stable ground outside of a landfill cell and having lateral line pipes connecting the gas header pipe to gas wells positioned in the landfill cell, wherein the lateral line pipes penetrate through the liner system of a landfill cell in a sealed containment unit.

2. Description of Related Art

Landfill gas (LFG) is produced from the anaerobic decomposition of organic waste in solid waste landfills. LFG is generally comprised of one-half methane, approximately one-half carbon dioxide and small amounts of organic compounds. Rather than engaging in prior practices of allowing LFG to escape into the atmosphere or simply flaring collected LFG, landfill operators are now recovering LFG from landfills to harvest the methane component for use as an energy source, which has proven to have environmental and economic benefits. The environmental benefits include a reduction in LFG odors in nearby communities and a reduction of air pollution that adversely affects the global climate. The financial benefits include a cost-effective collection of methane gas extracted from LFG produced in landfills for sale as a renewable energy source and avoidance of costly violations of environmental regulations.

Landfill construction guidelines are controlled by state legislation and vary between the states. Typically, a landfill cell includes an underlying liner system, a vegetated cap system, a leachate management system, a gas management system, erosion and sedimentation controls and various other monitoring systems. A properly constructed landfill cell is a self-contained bioreactor, which facilitates the decomposition of organic waste and production of LFG.

A gas management system installed in a landfill recovers, collects and disposes of LFG. Typically, a gas management system includes gas extraction wells inserted into solid waste in a landfill cell. Gas extraction wells connect by pipes to a gas header pipe. LFG is collected from a landfill through the gas management system by extraction through a vacuum in the system induced by negative air pressure placed on the gas header pipe. The vacuum draws LFG produced in the landfill through the gas wells and the pipes to a collection point for processing. The LFG at the processing location can be vented into the air, flared by a burner or processed to extract methane for use or sale.

A current gas management system incorporated into landfills includes extraction wells inserted into solid waste in a landfill cell, which are connected by lateral line pipes to a main header pipe. The main header pipe may be configured into a continuous ring-shaped system by connecting the ends of the pipe. The main header pipe may be alternatively be configured as a u-shaped system by capping the ends of the pipe. The lateral line connecting pipes and the gas header pipe are buried within the vegetated cap system of the landfill cell. A vacuum system, which is positioned outside of the landfill cell, is connected through a vacuum pipe to the gas header pipe. The vacuum system creates a negative pressure within the gas management system to facilitate the recovery and collection of LFG at a processing location outside of the landfill cell.

Due to the exothermic nature of solid waste decomposition, condensation builds up in the lateral line pipes and the main header pipe, which can block LFG removal by the gas management system, resulting in LFG emission from the landfill. Condensation buildup in the pipe system has been addressed by installing u-traps at preset locations along the main header pipe. A u-trap is a drainpipe connected to the bottom side of the main header pipe, all buried within the vegetative cap, for the purpose of draining condensation pooling in the main header pipe into the landfill cell.

Several problems exist with the current gas management system, which arise primarily from the anaerobic decomposition of the solid waste deposited within the landfill. During construction of the landfill, the solid waste dumped into the landfill provides a stable base for the overlying capping system. The stability of a newly constructed landfill cell offers a foundation for the installation of gas extraction wells, lateral line pipes and the gas header pipe within the solid waste and the overlying cap system.

A stable landfill cell is determinative for initial gradation of the main header pipe relative to the landfill cell, which promotes gravity-fed displacement of condensation flowing from the lateral line pipes into the main header pipe out of the u-trap into the landfill cell. During decomposition, solid waste is physically reduced in size, thereby creating a dynamic base under the overlying cap system, which randomly settles as the solid waste continues to decompose. As the overlying cap system settles along with the decomposing solid waste, the gas management system contained within the capping system also settles, which disrupts the preset grade of the main header pipe.

Once offset from its original position within the cap system with preset grades, the main header pipe is prone to condensation pooling at new low points along the gas header pipe. The new low points in the gas header pipe generally do not correspond with u-trap placement, so that the pooling condensation cannot drain throughout the gas header pipe to u-traps for return to the landfill cell. When enough condensation pools at low spots in the gas header pipe, the gas management system becomes partially or fully blocked, whereby LFG extraction by the vacuum is significantly reduced or totally precluded. The gas management system is considered watered-out when LFG extraction is partially or totally blocked by condensation pooling within the main header pipe.

A watered-out gas management system causes many problems. First, LFG is emitted into the air, rather than being extracted from the landfill cell and recovered by the gas management system. LFG emission is harmful to the environment, and coupled with LFG emission are the associated noxious odors, which can migrate to local areas. In addition to environmental issues related to LFG emission from a landfill, local authorities may cite a landfill operator for violation of environmental regulations. Second, the watered-out section of the main header pipe must be cleared to reestablish the vacuum in the gas management system for LFG extraction. Clearing a watered-out section of the main header pipe requires excavating the surrounding capping system and solid waste in the landfill. After excavation, the main header pipe is repositioned to establish a grade so the condensation drains to existing u-traps attached to the main header pipe. Alternatively, a new u-trap is installed at the watered-out section of the main header pipe. Repairing the watered-out main header pipe is time-intensive and adds substantial costs to the overall operation and maintenance of a landfill.

A landfill continues to settle at random locations in correlation with solid waste decomposition. The problem of watered-out sections of a gas header pipe persists until the organic components in the solid waste of the landfill are physically reduced to the smallest size through decomposition. Accordingly, a need exists for a gas management system for use with a landfill cell that overcomes the aforementioned problems associated with watered-out gas header pipes in gas management systems currently in use.

### SUMMARY OF THE INVENTION

The present invention provides a gas management system comprising a gas header pipe, condensation discharge wells and containment units. The present invention also provides a method of using the gas management system with a landfill cell to collect LFG produced by decomposing solid waste contained within the landfill cell.

The gas header pipe of the gas management system is provided within a trench surrounding the landfill cell. The gas header pipe is buried within a stable matrix to provide static conditions for the gas header pipe with fixed high points and low points.

Sequential condensation discharge wells are connected with the gas header pipe. The gas header pipe and a substantial portion of each condensation discharge well is buried within the trench in a stable matrix, which maintains the gas header pipe in a static condition. The gas header pipe is graded to have high points between each set of sequential condensation discharge wells placed at low points along the gas header pipe. The condensation discharge wells are positioned at fixed low points along the main header pipe so that condensation flowing within the gas header pipe will flow to the condensation discharge well for discharge from the gas management system by a pneumatic pump system.

Multiple lateral line pipes are provided to connect extraction wells within the landfill cell to the gas header pipe. Containment units are provided to communicate each lateral line connecting pipe through the liner system to the gas header pipe without compromising the integrity of the liner system, which functions to contain solid waste and its reduced components such as leachate within the landfill cell. Each containment unit comprises a large sleeve the length of a liner system of a landfill cell and two flat rings sealed to each end of the sleeve as well as the liner system. The two flat rings have central holes to provide communication for a lateral line connecting pipe through the containment unit. The lateral line connecting pipes are sealed to the two rings of the containment unit, which functions as a jacket around a lateral line connecting pipe at the point of penetration through the liner system.

A method is provided for collecting LFG from landfills with a gas management system incorporated within a landfill cell. The method comprises the steps of providing a gas management system adapted for use with a landfill cell to receive gas emitted from the landfill, collecting the gas emitted from the landfill, and discharging condensation pooling at low points of the gas management system, all of which occurs by implementing the disclosed gas management system. The step of collecting LFG emitted from the landfill cell occurs by placing a vacuum on a gas header pipe of the gas management system and collecting the gas emitted from a landfill cell by drawing the gas entering into the gas wells through the lateral line pipes and the gas header pipe of the gas management system to a processing system for containment, storage and/or methane gas removal. The step of discharging condensation includes collecting condensation buildup in the gas management system at low points in the gas header pipe and discharging the condensation from the low points in the gas header pipe with pumps.

### BRIEF DESCRIPTION OF THE DRAWINGS

FIG. 1 shows a partial sectional view of a landfill cell under construction with a gas header pipe positioned outside of a landfill cell in accordance with the present invention;

FIG. 2 shows a sectional view of the landfill cell under construction as shown in FIG. 1 with a gas header pipe connected to a lateral line pipe and containment unit penetrating a liner system of the landfill cell;

FIG. 3 shows a sectional view of the lateral line pipe and containment unit sealed to the liner system of the landfill cell as shown in FIG. 2;

FIG. 4 shows a perspective view of the containment unit as shown in FIG. 2;

FIG. 5 shows a perspective view of a section of a gas header pipe and sequential condensation discharge wells in a gas header trench in accordance with the present invention; and

FIG. 6 shows a sectional view of a condensation discharge well as shown in FIG. 5.

### DESCRIPTION OF THE EMBODIMENTS

The invention is generally described in terms of a gas management system for collection of LFG emitted from landfill cells. LFG enters the gas management system through gas wells inserted into the solid waste buried within the landfill cell. LFG emitted from a landfill is removed from a landfill cell by a vacuum placed on the gas management system, which draws LFG in gas wells through the lateral line pipes into the gas header pipe positioned outside of and surrounding the landfill cell. LFG is drawn further through the gas header pipe to a processing system known in the art to be capable of containment and storage of LFG and/or methane separation from LFG.

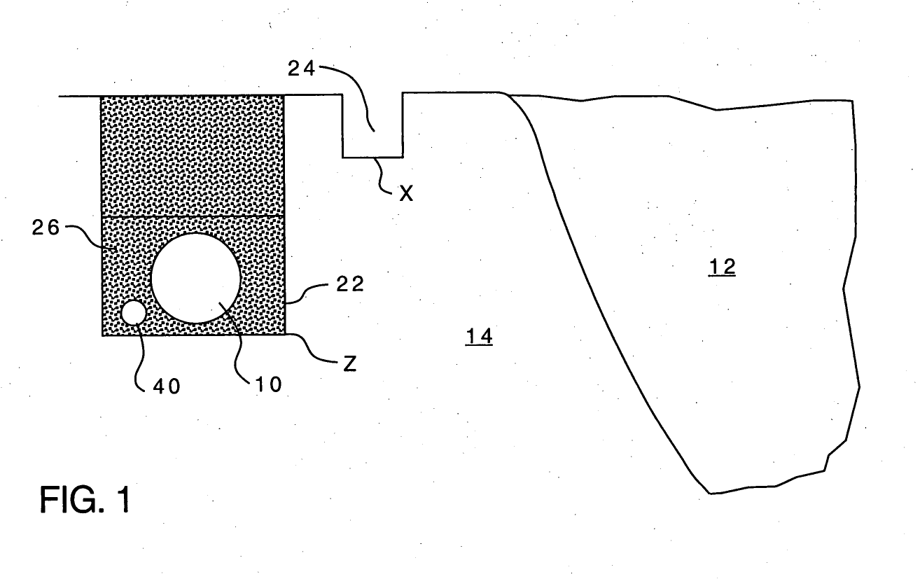

Referring to the drawings in which similar reference characters refer to similar parts throughout the several views thereof, FIGS. 1 through 6 illustrate the gas management system for collecting LFG emitted from landfills. The gas management system generally comprises gas header pipe 10 buried within stable ground 14 outside of and surrounding landfill cell 12, condensation discharge wells 16 connected to gas header pipe 10 at low points B, and lateral line pipes 18 housed within sealed containment units 56 at points where lateral line pipes 18 penetrate through liner system 20 of landfill cell 12. The gas management system is primarily a network of connected pipes used to collect LFG emission.

A key aspect of the present invention is the positioning of gas header pipe 10 as shown in FIGS. 1, 2 and 5. Gas header pipe 10 is positioned outside of landfill cell 12 to correct for problems associated with settlement of solid waste and an overlying cap system of landfill cell 12. Gas header pipe 10 is preferably an 18-inch diameter, HDPE/high density polyethylene pipe that is used by landfill engineers. In an alternative embodiment, gas header pipe 10 can be any pipe known in the art capable of serving as a gas header pipe and acceptable under environmental regulations.

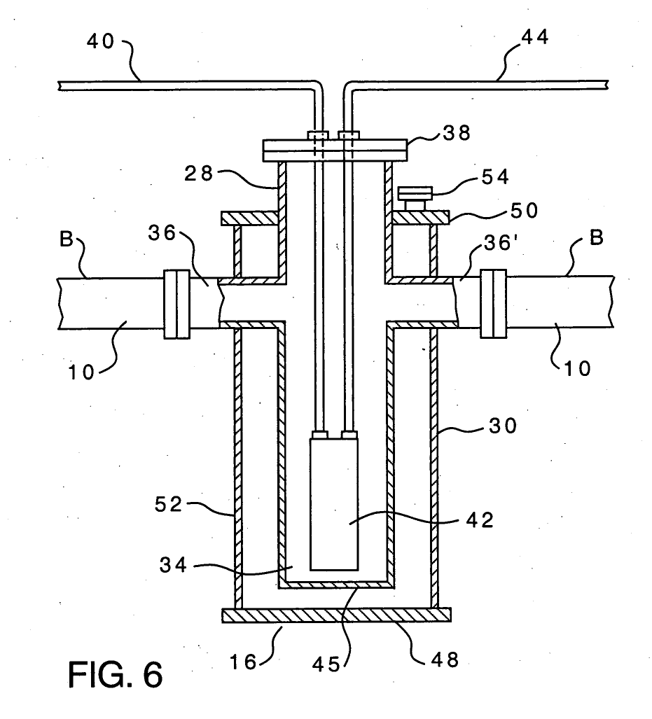

Gas header pipe 10 is placed in gas header trench 22 that is dug outside of anchor trench 24 surrounding landfill cell 12 as shown in FIGS. 1, 2 and 5. Bottom Z of gas header trench 22 is below bottom X of anchor trench 24. Gas header trench 22 is dug in stable ground 14 so that gas header pipe 10 can be buried in gas header trench 22 at calculated vertical heights from bottom Z of gas header trench 22, preferably in compacted clay 26 or, alternatively, in any of other preferable matrix such as gravel. Gas header pipe 10 is positioned within gas header trench 22 with high points A and low points B to create a grade. The vertical placement of gas header pipe 10 promotes the flow of condensation through lateral line pipes 18 to gas header pipe 10 of an operable gas management system, particularly to low points B of gas header pipe 10. At low points B of gas header pipe 10, condensation discharge wells 16 are attached to gas header pipe 10. The grade of gas header pipe 10 allows for gravity-fed flow of condensation through the gas management system to condensation discharge wells 16 at low points B of gas header pipe 10. Low points B of gas header pipe 10 lie adjacent the lowest points of the gas management system, which is any reservoir 34 of condensation discharge well 16 as shown specifically in FIG. 6.

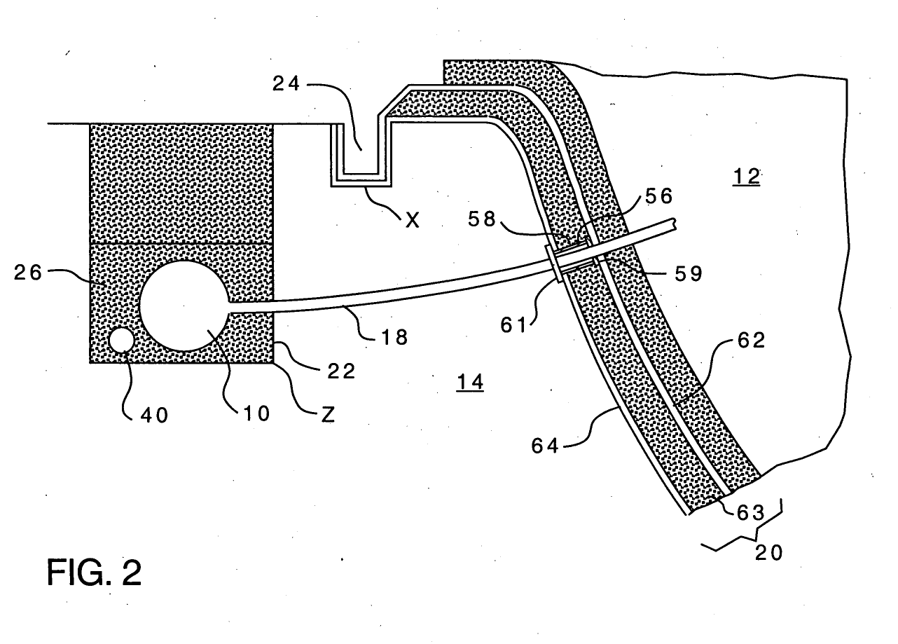

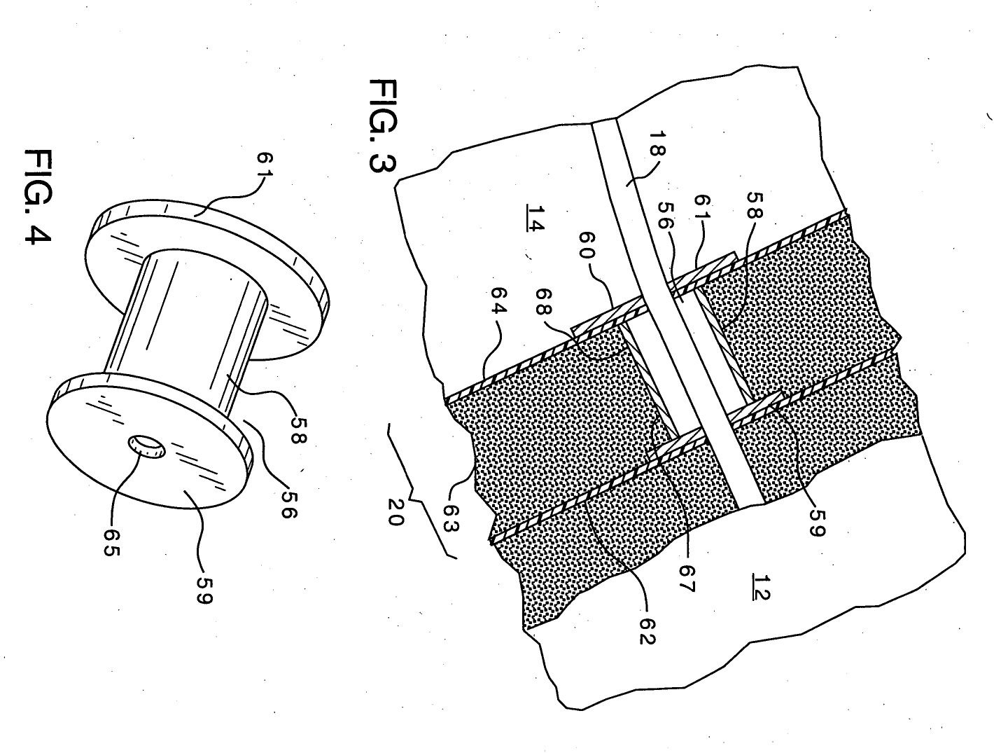

FIGS. 2, 3 and 4 show lateral pipe containment unit 56, which is a further component of the gas management system. Lateral pipe containment unit 56 is comprised of a section of pipe 58 and first cap 59 and second cap 61 to provide a sealed jacket around the portion of lateral line pipe 18 passing through liner system 20. The length of the section of pipe 58 corresponds with the depth of clay 63 between primary liner 62 and secondary liner 64 of liner system 20. First cap 59 and second cap 61 have a diameter larger than the diameter of the section of pipe 58, and first cap 59 and second cap 61 have first hole 65 and second hole (not shown), respectively, configured to house lateral line pipe 18 as shown particularly in FIG. 4. First cap 59 is sealed to first end 67 of the section of pipe 58 and to primary liner 62 as shown particularly in FIG. 3. Second cap 61 is sealed to second end 68 of the section of pipe 58 and secondary liner 64 also shown particularly in FIG. 3. First cap 59 and second cap 61 have first hole 65 and second hole (not shown), respectively, to receive lateral line pipe 18, which passes through lateral pipe containment unit 56. Lateral line pipe 18 is sealed with a sealant to first hole 65 and second hole (not shown) of first cap 59 and second cap 61, respectively.

Lateral pipe containment unit 56 provides a sealed passageway for lateral line pipe 18 buried within landfill cell 12 to penetrate through multi-layer liner system 20 of landfill cell 12. After configuration of lateral pipe containment unit 56 with liner system 20, the containment effect of liner system 20 will not be breached due to the seals between first cap 59, primary liner 62 and lateral line pipe 18 and second cap 61, second liner 64 and lateral line pipe 18. Sealed lateral pipe containment unit 56 blocks the passage of leachate or any other fluid out of landfill cell 12. Lateral pipe containment unit 56 is installed in a manner that is in full compliance with environmental regulations.

FIGS. 1, 2 and 5 show gas header pipe 10 positioned to surround landfill cell 12 in gas header trench 22. Preferably, the ends of gas header pipe 10 are connected together to create a continuous pipe system around landfill cell 12. Alternatively, the ends of gas header pipe 10 are capped so that gas header pipe 10 is not continuous. In either embodiment, the purpose of gas header pipe 10 is to provide a main LFG collection and transfer pipe connected by lateral line pipes 18 to the gas wells that is capable of collecting and discharging condensation that typically builds up in a gas management system.

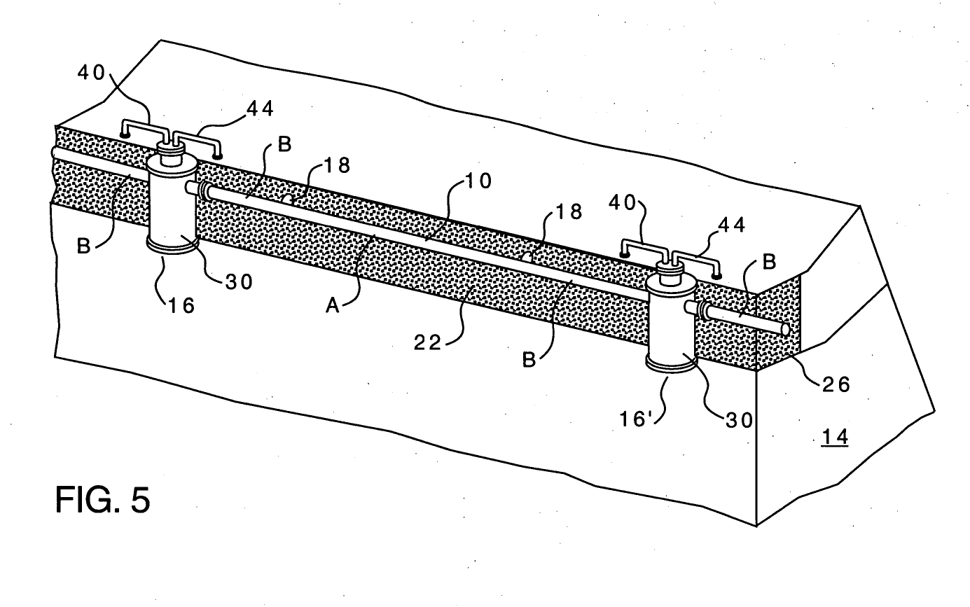

FIG. 5 shows sequential condensation discharge wells 16, 16′. Preferably, condensation discharge well 16, in a typical configuration shown particularly in FIG. 6, is comprised of t-shaped pipe 28 in fluid communication with gas header pipe 10, containment unit 30 that primarily houses t-shaped pipe 28, and a pneumatic pump system for discharging condensation that collects in condensation discharge wells 16. The purpose of condensation discharge well 16 is to collect and discharge condensation from the gas management system in a controlled fashion without disrupting the collection of LFG emitted from landfill cell 12 by the gas collection system. Condensation discharge wells 16 are placed in gas header trench 22 along with gas header pipe 10 at low points B of gas header pipe 10.

As shown in more detail in FIG. 6, t-shaped pipe 28 is the primary component of condensation discharge well 16. T-shaped pipe 28 is in fluid communication with gas header pipe 10 by way of side arms 36, 36′ of t-shaped pipe 28. The bottom of t-shaped pipe 28 is sealed with cap 45 to create reservoir 34 to collect condensation before discharge from the gas management system. The top of t-shaped pipe 28 has cap 38 that covers the top of t-shaped pipe 28. The purpose of t-shaped pipe 28 is to provide reservoir 34, which is the final resting place for condensation flowing through the gas management system before discharge by pneumatic pump 42 of a pneumatic pump system. T-shaped pipe 28 is preferably HDPE/high density polyethylene pipe used by landfill engineers or any other type of pipe such as another polymeric or metallic based pipe known in the art that is suitable.

As is also shown in FIG. 6, a pneumatic pump system is another component of condensation discharge well 16. The pneumatic pump system can be any pump system known in the art that is capable of displacing water. Preferably, the pneumatic pump system is comprised of an air inlet line 40, pneumatic pump 42 and discharge line 44 as shown in FIGS. 5 and 6. Air inlet line 40 is placed within gas header trench 22. Air inlet line 40 and discharge line 44 penetrate through and are sealed to cap 38 of t-shaped pipe 28. Air inlet line 40 is connected to pneumatic pump 42 that is placed in reservoir 34 of t-shaped pipe 28. Air inlet line 40 is charged with air by a compressor so that, when pneumatic pump 42 is activated, condensation is pumped out of reservoir 34 through discharge line 44 preferably into landfill cell 12 or, alternatively, to another location for treatment (not shown). Pneumatic pump 42 is activated when condensation within reservoir 34 reaches a prescribed height so that the condensation is pumped out of reservoir 34 through discharge line 44.

The containment unit 30 is a further component of condensation discharge well 16 as shown in FIGS. 5 and 6. Containment unit 30 provides a safety measure by housing a majority of t-shaped pipe 28 of condensation discharge well 16. Containment unit 30 is comprised of a large section of pipe 52 with base 48 and cap 50. Preferably, pipe 52 has a 36-inch diameter. Base 48 is sealed to the bottom of pipe 52 to close the bottom of pipe 52. Cap 50 has a hole large enough to receive t-shaped pipe 28 and is also sealed to the top of pipe 52. Sealable test port 54 is also attached to cap 50 to allow for visual inspection of the interior compartment of containment unit 30. The components of containment unit 30 are primarily comprised of metal or an alternative composite such as polymer, which would serve the purpose of the invention.

A method of collecting LFG by using the disclosed gas management system is also provided by the invention. Generally, the method includes the steps of providing the gas management system adapted for use with landfill cell 12 to receive gas emitted from landfill cell 12, collecting the gas emitted from landfill cell 12, and discharging condensation buildup collecting at the lowest points of the gas management system. The method features all of the elements comprising the gas management system including the gas wells, lateral line pipes 18 and lateral pipe containment units 56 and gas header pipe 10 and condensation discharge wells 16 and pump system.

The method includes the step of providing a gas management system adapted for use with landfill cell 12 to receive gas emitted from landfill cell 12. The step is further characterized by providing gas wells through a cap of landfill cell 12 into the solid waste buried within landfill cell 12. The gas wells are positioned in landfill cell 12 after landfill cell 12 is filled with solid waste and covered with the capping system. The step is also further characterized by positioning gas header pipe 10 outside of landfill cell 12 to surround landfill cell 12. Gas header pipe 10 is vertically positioned with high points A and low points B in gas header trench 22. At low points B of gas header pipe 10, gas header pipe 10 connects to side arms 36, 36′ of t-shaped pipe 28 of condensation discharge well 16 sealed in a containment unit 30. Gas header pipe 10 and condensation discharge wells 16 are positioned during the construction of landfill cell 12. The step is also characterized by connecting the gas wells by lateral line pipes 18 to gas header pipe 10 to provide a pipe system adapted for use with landfill cell 12 to receive gas emitted from landfill cell 12. Lateral line pipes 18 penetrate through multi-layered liner system 20 of landfill cell 12 and are contained in containment unit 56 sealed to liner system 20. Lateral line pipes 18 are installed during construction of landfill cell 12 and are partially buried by solid waste and ultimately the cap system of landfill cell 12. Lateral line pipes 18 are connected to the gas wells after installation of the gas wells in completed landfill cell 12.

The method also includes the step of collecting gas emitted from landfill cell 12 once construction of landfill cell 12 is completed. The step is characterized by placing a vacuum on gas header pipe 10 of the gas management system and collecting the gas emitted from landfill cell 12 by drawing the gas from gas wells through lateral line pipes 18 and gas header pipe 10 of the gas management system to a process system for collection and storage of LFG. The process system is a system capable of collecting LFG and separating methane from the LFG for further containment of purified methane gas.

The method also includes the step of discharging condensation buildup within the gas management system. During decomposition of solid waste, heat is given off by exothermic reaction, which creates condensation within the gas management system. Condensation flows through lateral line pipes 18 in gas header pipe 10, where the predisposed high and low points A and B, respectively, promote the flow of condensation to the lowest point of the gas management system, namely reservoir 34 of t-shaped pipe 28 of condensation discharge well 16.

The condensation flows through the gas management system to lowest point B for collection. As the condensation is collected in reservoir 34, it reaches a preset level, which activates pneumatic pump 42 of the pump system. Pneumatic pump 42 is charged with air pressure, which is used to pump the condensation collected in reservoir 34 out of condensation discharge well 16 by discharge line 44. Discharge line 44 displaces the condensation from the gas management system preferably to a location for treatment or, alternatively, back into landfill cell 12.

Although the invention has been described with reference to the disclosed embodiments, this disclosure is illustrative and exemplary of the present invention and is made merely for purposes of providing a full disclosure of the invention. Other embodiments of the invention can achieve the same result. Accordingly, other embodiments, adaptations, variations, modifications and equivalent arrangements will be apparent to those skilled in the art.

1. A gas management system for collecting landfill gas from a landfill cell, the gas management system comprising:
a gas well positioned in a landfill cell;
a lateral line pipe connecting the gas well to a gas header pipe positioned outside of the landfill cell; and
a containment unit which is connected to the lateral line pipe where it penetrates the liner system of the landfill cell.

2. The gas management system of claim 1, wherein the containment unit receives the lateral line pipe where the lateral line pipe penetrates the liner system of the landfill cell.

3. The gas management system of claim 1, wherein the gas wells are perforated pipe inserted through a cap of the landfill cell into solid waste buried in the landfill cell.

4. The gas management system of claim 1, wherein the gas header pipe is vertically positioned with high points and low points surrounding the landfill cell, and wherein the gas header pipe is connected to arms of a t-shaped pipe of a condensation discharge well at a low point of the gas header pipe.

5. The gas management system of claim 4, wherein a pump connected to a pump system having a discharge pipe is positioned at the bottom of the t-shaped pipe.

6. The gas management system of claim 5, wherein the pump system comprises an inlet line, a pump and a discharge line for discharging condensation in the bottom of the t-shaped pipe.

7. The gas management system of claim 1, wherein the containment unit comprises a tube capable of traversing the space between a first liner and a second liner of the landfill cell liner system with a first end and a second end, a first circular cap sealed to the first end of the tube and the first liner with a hole to sealably receive the lateral line pipe, and a second circular cap sealed to the second end of the tube and the second liner with a hole to sealably receive the lateral line pipe.

8. A method for collecting gas emitted from a landfill, the method comprising the steps of:
providing a gas management system adapted for use with a landfill cell to receive gas emitted from the landfill;
collecting the gas emitted from the landfill; and
discharging condensation collecting at one or more of the lowest points of the gas management system.

9. The method of claim 8, wherein the step of providing a gas management system comprises:
providing gas wells through a cap of the landfill cell into the solid waste buried within the landfill cell;
positioning a gas header pipe outside of the landfill cell surrounding the landfill cell; and
connecting the gas wells by a lateral line pipe to the gas header pipe.

10. The method of claim 9, wherein the gas header pipe is vertically positioned with high points and low points, and wherein the gas header pipe connects to arms of a t-shaped pipe at a low point of the gas header pipe.

11. The method of claim 9, wherein the lateral line pipe penetrates through a liner system in a containment unit sealed to the liner system of the landfill cell.

12. The method of claim 8, wherein the step of collecting gas emitted from the landfill cell comprises:
placing a vacuum on a gas header pipe of the gas management system; and
collecting the gas emitted from the landfill cell by drawing the gas in gas wells through lateral line pipes and the gas header of the gas management system to a collection system.

13. The method of claim 8, wherein the step of discharging condensation pooling at low points of the gas management system comprises:
collecting condensation buildup in the gas management system at one or more low points in a gas header pipe; and
discharging the condensation from the one or more low points in the gas header pipe with pumps.

14. A gas management system for collecting gas emission from a landfill comprising gas wells positioned in a landfill cell, the gas wells connected to lateral line pipes penetrating through a landfill cell liner of the landfill cell in a sealed containment unit, the lateral line pipes connected to a gas header pipe positioned outside of the landfill cell, the gas header pipe vertically positioned with high points and low points, and condensation discharge wells connected to the gas header pipe at low points of the gas header pipe.
